(19) United States
(12) Patent Application Publication
(10) Pub. No.: US 2009/0056144 A1
(43) Pub. Date: Mar. 5, 2009

(54) Razor Cutting Head for Electric and Non-Electric Razors

(76) Inventor: David Shore, Boca Raton, FL (US)

Correspondence Address: BROMBERG & SUNSTEIN LLP, 125 SUMMER STREET, BOSTON, MA, 02110-1618, US

(21) Appl. No.: 11/845,293

(22) Filed: Aug. 27, 2007

(51) Int. Cl. B26B 19/00; B26B 19/38

(52) U.S. Cl. 30/50; 30/539

(57) ABSTRACT

A cutting head for an electric razor is described. The cutting head includes a blade support member and a plurality of blades. The blade support member can attach to an electric razor and reciprocate back and forth. The plurality of blades are located on the blade support member, and move in a cutting direction towards a hair to be cut. The plurality of blades meet the hair to be cut at a contact angle that is acute with respect to the cutting direction.

### FIELD OF THE INVENTION

The invention generally relates to razors and electric razors. More specifically, the invention relates to a new razor cutting head design for razors and electric razors.

### BACKGROUND ART

There are numerous electric and non-electric razors commercially available for personal grooming purposes and the number is growing. Manufacturers are continuously redesigning existing razor designs to get “closer” and “more comfortable” shaves. Many of these improvements include adding additional blades or some type of moisturizer or lubricating strip to the razor head. Despite these advancements, many consumers are still not satisfied with the currently available razors.

Of the numerous choices, there are primarily two leading electric razor head types—reciprocating and rotating. FIGS. 1A-1D illustrate examples of the reciprocating type, whereas FIG. 1E illustrates a rotating design. The main difference between the two is the manner in which the blades move and cut hair. As the name suggests, the rotating head rotates. As the head rotates, blades attached to the head cut hair in a manner similar to a standard lawnmower. Conversely, the reciprocating style electric razor head moves back and forth in a linear manner over the skin and cuts hairs as it passes.

Both of the above described razor head designs provide inefficient cutting. As the blade comes into contact with the hair, the force applied to the hair follicle causes the hair to deform and/or bend. As the hair bends, the blade, in many instances, will cut the hair at a higher point or will jaggedly cut the hair. In either instance, the razor fails to provide the “clean” and “close” shave desired by consumers.

### SUMMARY OF THE INVENTION

Embodiments of the present invention are directed towards a cutting head for an electric razor. The cutting head may include a blade support member and a plurality of blades. The blade support member may attach to an electric razor and reciprocate back and forth. The plurality of blades may be located on the blade support member. In addition, the plurality of blades move in a cutting direction towards a hair to be cut and have a contact angle that is acute with respect to the cutting direction. In some embodiments, the contact angle is between 30 and 60 degrees. In other embodiments, the contact angle is substantially 45 degrees.

In accordance with some embodiments, the cutting head may also include a screen that covers the plurality of blades. The screen protects a user from cuts that may be caused by the plurality of blades. The plurality of blades may be integral to the blade support member. The plurality of blades may also include a cutting surface formed at the edge of grooves cut into the blade support member.

In alternative embodiments, the cutting head for an electric razor may include a blade support member, a plurality of disc members, and a plurality of blade members. The blade support member may attach to an electric razor. The plurality of disc members may attach to the blade support member in an array and may rotate about an axis such that the rotation is substantially planar with the blade support member.

The plurality of blade members may extend radially out from each of the plurality of disc members, and move in a cutting direction towards a hair to be cut. Each of the plurality of blade members may have a contact angle that is acute with respect to the cutting direction. In some embodiments, the plurality of blade members are swept such that the blade member is convex with respect to the cutting direction. In other embodiments, the plurality of blade members are swept such that the blade member is concave with respect to the cutting direction.

In accordance with some embodiments, the contact angle of each of the plurality of blade members can be between 30 and 60 degrees. In accordance with other embodiments, the contact angle of each of the plurality of blade members can be substantially 45 degrees. The cutting head may also have a screen covering the array of disc members and configured to protect a user from cuts caused by the plurality of blade members.

In accordance with other embodiments, a cutting head for a razor may include a blade support member and a plurality of blades. The blade support member can attach to a razor handle. The plurality of blades may be located in and supported by the blade support member. The plurality of blades move in a cutting direction towards a hair to be cut and have a contact angle that is acute with respect to the cutting direction. In some embodiments, the contact angle is between 30 and 60 degrees. In other embodiments, the contact angle is substantially 45 degrees.

### BRIEF DESCRIPTION OF THE DRAWINGS

FIGS. 1A to 1D show prior art reciprocating electric razor heads similar to those that are currently commercially available.

FIG. 1E show prior art rotating electric razor heads similar to those that are currently commercially available.

FIG. 2A schematically shows a top view of a blade from a prior art razor head contacting a hair.

FIG. 2B schematically shows a top view of a blade from a razor head in accordance with embodiments of the present invention contacting a hair.

FIG. 2C schematically shows a side view of a blade contacting a hair in accordance with embodiments of the present invention.

FIG. 2D schematically shows a top view of a blade contacting a hair at a substantially 90 degree contact angle. This figure also shows the distance from the cutting edge to the maximum blade thickness.

FIG. 2E schematically shows a top view of a blade contacting a hair at an acute contact angle. This figure also shows the distance from the cutting edge to the maximum blade thickness.

FIG. 3A schematically shows a top view of an exemplary reciprocating razor head in accordance with embodiments of the present invention.

FIG. 3B schematically shows a side view of an exemplary reciprocating razor head in accordance with embodiments of the present invention.

FIG. 3C schematically shows a top view of an exemplary reciprocating razor head with screen in accordance with embodiments of the present invention.

FIG. 3D schematically shows a side view of an exemplary reciprocating razor head with screen in accordance embodiments of the present invention.

FIG. 4A schematically shows a top view of an exemplary rotating razor head in accordance with embodiments of the present invention.

FIG. 4B schematically shows a side view of an exemplary rotating razor head in accordance with embodiments of the present invention.

FIG. 5 schematically shows a front view of an exemplary razor head for a non-electric razor in accordance with embodiments of the present invention.

### DETAILED DESCRIPTION OF SPECIFIC EMBODIMENTS

Embodiments of the present invention provide new razor head designs that provide superior shaves as compared to razors currently on the market. Specific embodiments include blade support members and a variety of blades that contact hairs at angle. The new razor design can be incorporated into rotating electric razors, reciprocating electric razors, and standard non-electric razors.

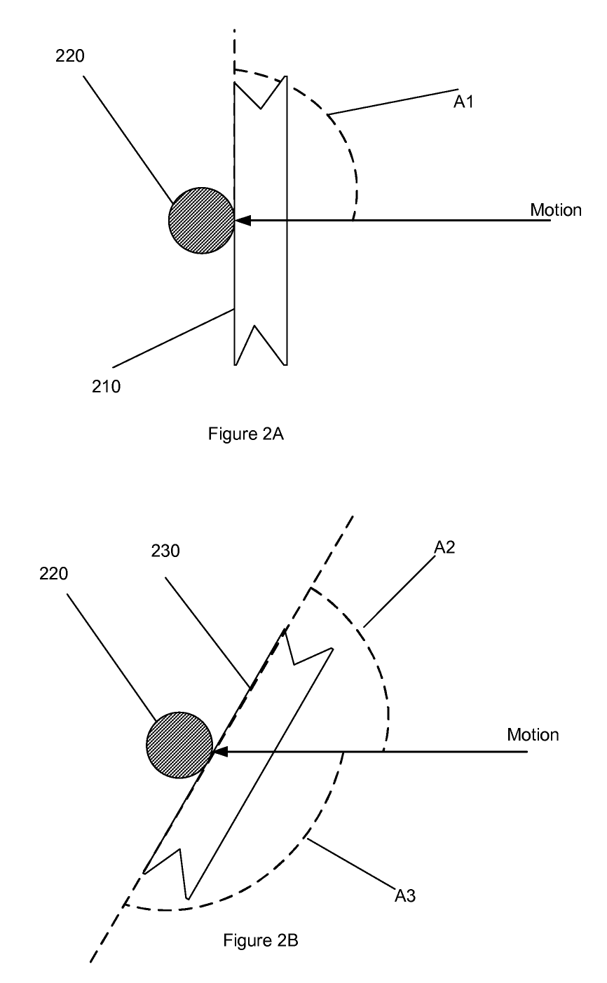

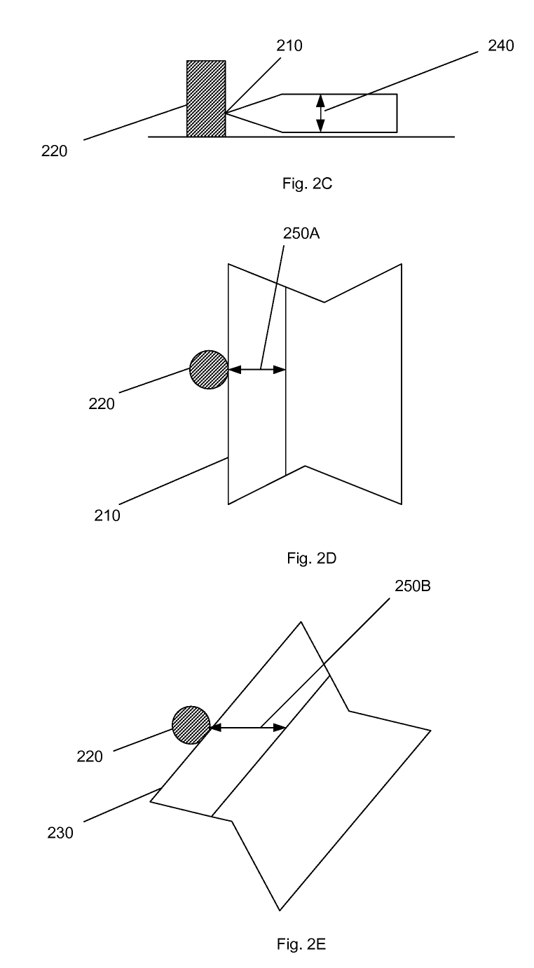

As shown in FIG. 2A, prior art razor head designs typically have razors and/or cutting edges 210 that engage a hair 220 at a contact angle A1 that is substantially 90 degrees. This design is problematic because, in many instances, the hair's resistance to being cut will be at its greatest and the cutting edge 210 will bend and deform the hair 220 as it contacts the hair 220. The deformation and bending negatively impact the cutting and can inhibit the quality and effectiveness of the shave.

As shown in FIG. 2b, embodiments of the present invention provide razor heads with cutting edges 230 that engage the hair 220 at an acute contact angle A2. Contacting the hair 220 at an acute contact angle A2 greatly reduces the resistance and increases the force per area. The reduced resistance and increased force per area essentially eliminates the deformation and bending of the hair 220 upon contact with the cutting edge 230, creating a cleaner, closer shave.

The reduced resistance discussed above comes predominately from two factors. First, the acute contact angle A2 causes the cutting edge 230 to move in a somewhat side-wise manner. This side-wise movement causes the cutting edge 230 to contact a reduced section of the hair 220 and increases the force per area. Second, as discussed in greater detail below, the acute contact angle A2 reduces the effective thickness of the cutter.

As briefly mentioned above, the acute contact angle A2 reduces the effective thickness of the cutting surface. In particular, as shown in FIGS. 2C through 2E, regardless of how sharp a cutter is made, the cutter has a thickness 240 that is a distance 250A/B away from the cutting edge 210/230. As the cutter begins to cut through the hair 210, the thickness 240 essentially acts to dull the cutter (e.g., the cutter will not cut the hair 220 as effectively). However, when the cutter is angled as described above (e.g., so that it has an acute contact angle A2), the distance 250A/B from the cutting edge to the thickness 240 increases (e.g., distance 250B is greater than distance 250A), thereby decreasing the effective thickness of the cutter. This reduction in effective thickness preserves much of the sharpness of the cutting edge 230, and allows the cutter to cut more effectively.

The amount of the reduction in effective thickness is dependent upon the degree of the acute contact angle A2. As the acute contact angle A2 decreases, the distance 250B increases. As mentioned above, this increase in distance 250B decreases the effective thickness (and effectively makes the cutter sharper). Table 1 shows the effective cutting surface thickness for three specific acute contact angles A2—30, 45, and 60 degrees. It is important to note that the values within the effective thickness column are the relative thicknesses as compared to a standard 90 degree contact angle. For Example, at 60 degrees, the cutting surface has a thickness that is approximately 0.866 (e.g., 86.6%) that of a 90 degree cutting surface.

TABLE 1
Effective Cutting Surface Thicknesses

| Acute Contact Angle | Effective Thickness |
|---|---|
| 30 degrees | 0.500 |
| 45 degrees | 0.707 |
| 60 degrees | 0.866 |

It can be seen from the above Table 1 that a 30 degree contact angle A2 has the greatest reduction in effective thickness (e.g., 0.500 that of a 90 degree blade). Additionally, there is little advantage to be gained at an acute contact angle A2 above 60 degrees. Although angles between 30 and 60 degrees are described above, acute contact angles A2 less than 30 degrees can be used when construction, materials, and cost factors are favorable.

Various embodiments incorporating the acute contact angle design are described in greater detail below. It is important to note that although the various embodiments described below refer to an acute contact angle A2, many embodiments will also necessarily have an obtuse contact angle A3 (FIG. 2B). As one of ordinary skill in the art would readily understand, the sum of the acute contact angle A2 and the obtuse angle A3 should equal 180 degrees for a straight-edged cutting surface. Therefore, as the acute contact angle A2 increases, the obtuse contact angle A3 will decrease. However, for ease of explanation and understanding, we will only refer to the acute contact angle A2.

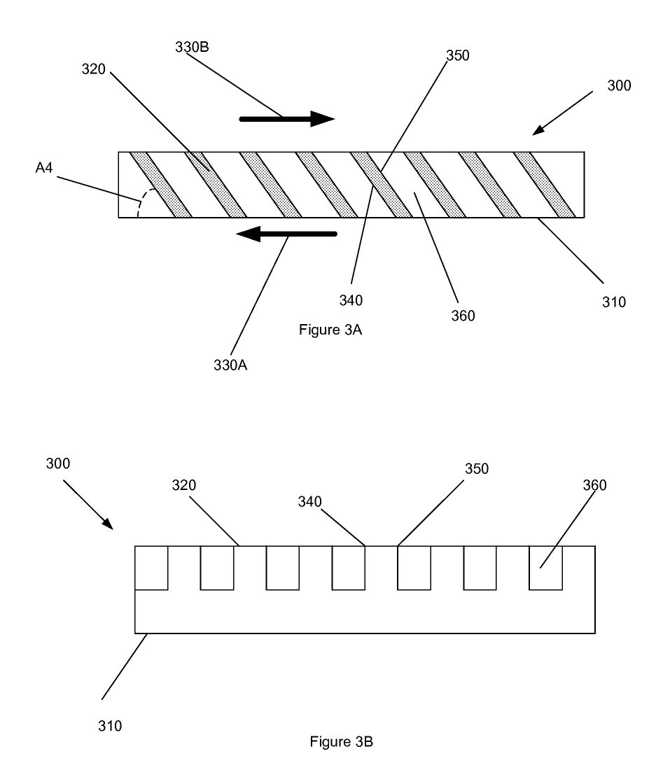

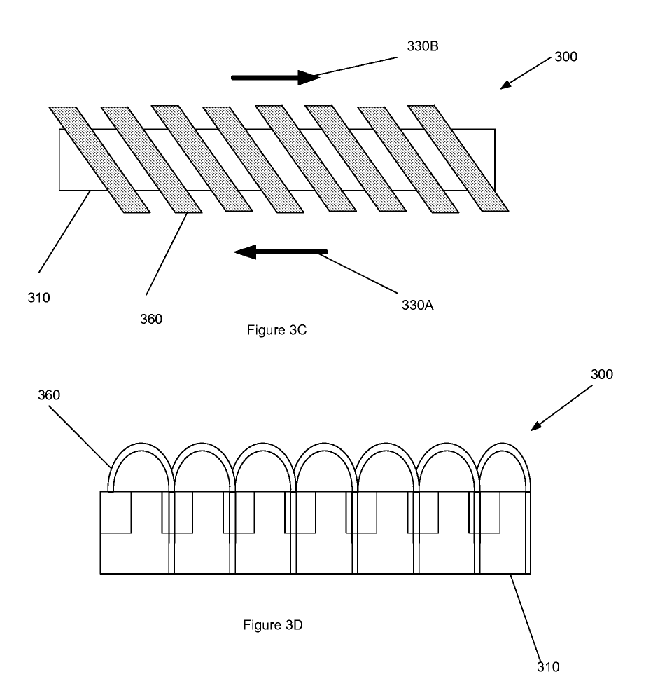

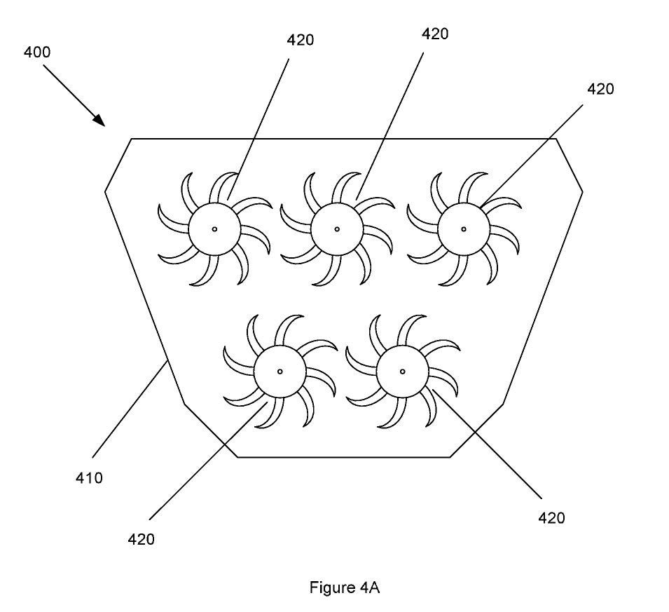

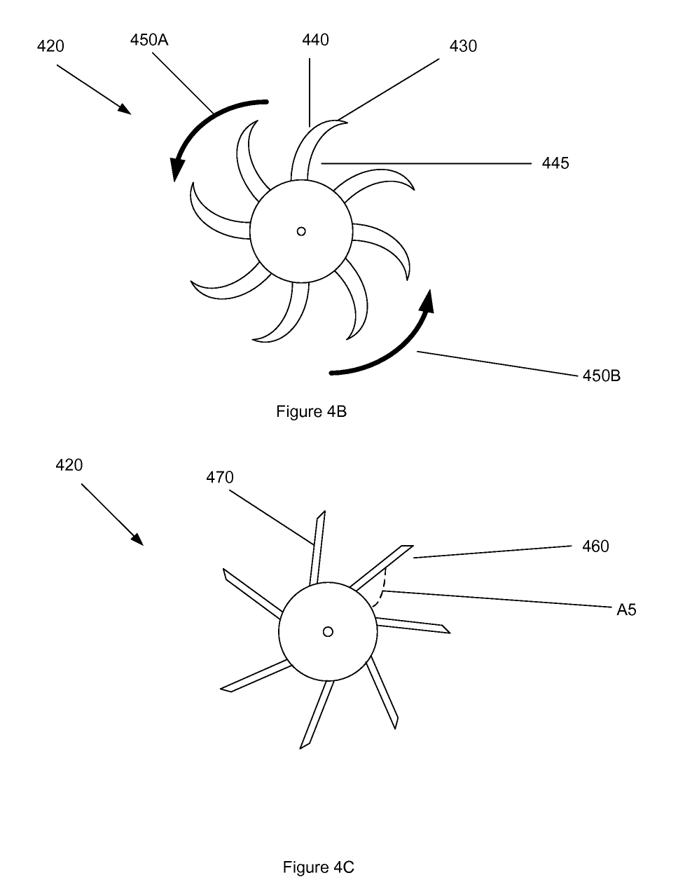

FIGS. 3A and 3B show a top and side view, respectively, of one embodiment of a reciprocating razor head 300. The reciprocating razor head 300 includes a blade support member 310 that supports a plurality of blades 320. The reciprocating razor head 300 linearly moves back and forth along a line, as shown by arrows 330A and 330B. As the razor head moves back and forth, the blades contact and cut the hairs protruding from the skin. Each of the blades 320 can have one or more cutting surfaces 340 and 350 for cutting hairs. For example, as shown in FIG. 3A, the blades 320 can have a first cutting edge 340 on the left side of the blade 320 and a second cutting edge 350 on the right side of the blade 320. This increases the amount of cutting by allowing the blade to cut on both the forward and backwards reciprocation of the razor head 300.

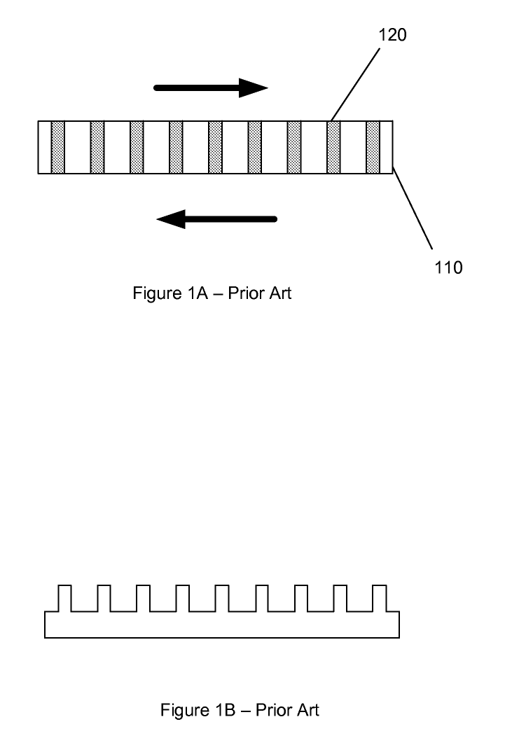

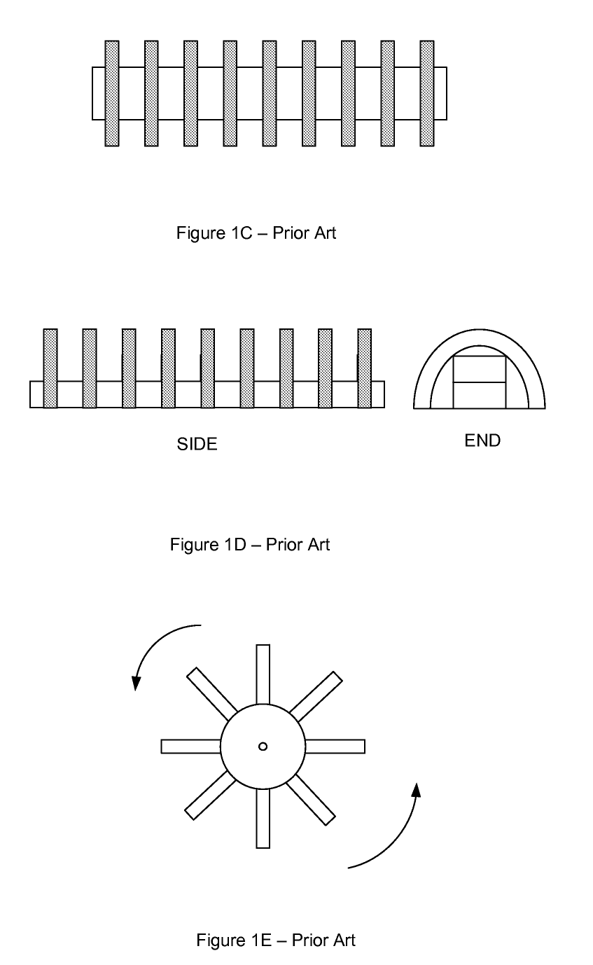

In contrast to the prior art razor heads shown in FIGS. 1A to 1D in which the blades 120 are perpendicular with respect to the blade support member 110 and have an a 90 degree contact angle A1, the blades in reciprocating head 300 are oriented at an angle A4 with respect to the blade support member 310. This angle A4 helps establish the acute contact angle A2 with respect to the linear motion, as described above.

In accordance with some embodiments of the present invention, the blades 120 can be integral to the blade support member 310. For example, as shown in FIGS. 3A and 3B, the blades 320 and cutting surfaces 340 and 350 can be formed by cutting grooves 360 into the blade support member 310. In such embodiments, the blades 320 are essentially the raised portions and the cutting surfaces 340 and 350 are formed at the edges of the raised portion. Alternatively, the blades 320 can be separate and distinct elements that are secured to the blade support member 310 during manufacturing.

As mentioned above, the blade support member 210 can attach to a variety of reciprocating type electric razors. Therefore, the blade support member 210 can have an attachment means located on the bottom of the support member 210. The exact type of at attachment means will depend on the make and model of the electric razor to which the razor head 200 is being attached.

Although the blades 220 will provide an improved shave at a variety of acute contact angles A2, it is preferable that the acute contact angle A2 be between 30 and 60 degrees. In embodiments having cutting surfaces 340/350 on both sides of the blades 220, it is preferable that the acute contact angle A2 be 45 degrees so that each cutting surface 340/350 meets the hairs to be cut at the same angle regardless of whether it is on the forward or backward reciprocation.

As shown in FIGS. 4A and 4B, an acute contact angle design can also be incorporated into rotating electric razor heads. In a similar manner as the reciprocating head 300 described above, the rotating electric razor head 400 includes a blade support member 410 that can attach to an electric razor. The blade support member 400 supports a number of rotating cutting discs 420. The rotating cutting discs 420 can be arranged in an array on the blade support member 410 to provide maximum shaving coverage. When a user turns on the electric razor, motors within the electric razor and connected to the rotating cutting discs 420 will cause the cutting discs to rotate.

It is important to note that, although FIG. 4A shows five cutting discs 420 in a 3×2 array, any number and arrangement of cutting discs 420 can be used. The number and array arrangement may be dependent on the type and application of the electric razor. For example, certain embodiments may include six cutting discs 420 in a 3×3 array or 2×2×2 array. Alternatively, the rotating electric razor head 400 can include more or less cutting discs 420.

Each of the rotating cutting discs 420 include a number of blade members 430 extending radially out from the center of the cutting discs 420, FIG. 4B. As shown in FIG. 4B, the blade members 430 can be swept such that they have a curved cutting surface 440. The curved cutting surface 440 and the rotation of the cutting discs 420 (as indicated by arrows 450A/B) cause the blade member to meet the hair 220 at an acute contact angle A2 in a manner similar to that described above. Again, this acute contact angle A2 reduces the resistance and increases the force per area, thereby creating a cleaner, closer shave. Additionally, the acute contact angle A2 reduces the effective thickness of the cutting surface 440 as shown in Table 1.

In some embodiments of the rotating electric razor head 400 and as mentioned above, the blade members 430 can be curved or swept, as shown in FIG. 4B. The swept blade members 430 create a convex surface 440 and a concave surface 445. Although FIG. 4B shows the convex surface as the cutting surface, some embodiments can be arranged such that the concave surface 445 acts as the cutting surface. In either embodiment, the swept blade will have an acute contact angle with the hair to be cut, as described above.

It is important to note that, although the cutting discs 420 are shown to have swept blades 430, the cutting discs can have also have non-swept (e.g., straight edged) blades 460, FIG. 4C. To provide the appropriate contact angle A2 the non-swept blades 460 can extend out from the cutting disc 420 at an angle A5. Therefore, in a manner similar to the swept blades 430, the angle A5 and the rotation of the cutting discs 420 cause the cutting surface 470 of the non-swept blade 460 to meet the hair 220 at an acute contact angle A2, the benefits of which are described above.

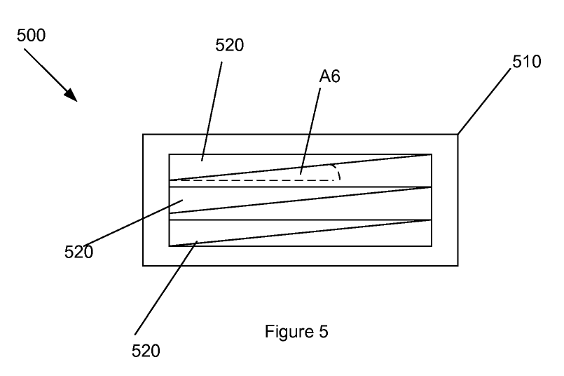

In accordance with some embodiments of the present invention, the benefit of having an acute contact angle can also be incorporated into a standard, non-electric razor head, as shown in FIG. 5. In such embodiments, the non-electric razor head 500 includes a blade support member 510 for attaching the razor head 500 to a razor handle (not shown) and supporting a number of blades 520. To provide the desired angle of engagement, the blades 520 can have a blade angle A6 that creates an angled cutting surface 530.

Although the acute contact angle A2 and blade angle A6 can be any angle suitable for cutting a hair, in preferred embodiments of this non-electric razor head the acute contact angle ranges between 30 and 60 degrees. However, because non-electric razors typically only operate in a single direction, best results are likely achieved at an acute contact angle of 30 degrees due to the lowest effective thickness (see Table 1).

It is important to note that, although the Figures corresponding to the above described embodiments show a specific number of blades, embodiments in accordance with this invention can have any number of blades or blade members. For example, the non-electric shave head 500 can have 1 or more blades 520. Additionally, the rotating shave head 400 can have more or less than 5 rotating discs 420 in the array and each rotating disc 420 can have more or less than 8 blade members 430.

Although various exemplary embodiments of the invention have been disclosed, it should be apparent to those skilled in the art that various changes and modifications can be made which will achieve some of the advantages of the invention without departing from the true scope of the invention.

What is claimed is:

1. A cutting head for an electric razor comprising:
a blade support member configured to attach to an electric razor and reciprocate back and forth;
a plurality of blades located on the blade support member, the plurality of blades moving in a cutting direction towards a hair to be cut and having a contact angle that is acute with respect to the cutting direction.

2. A cutting head for an electric razor according to claim 1, wherein the contact angle is between 30 and 60 degrees.

3. A cutting head for an electric razor according to claim 1, wherein the contact angle is substantially 45 degrees.

4. A cutting head for an electric razor according to claim 1 further comprising a screen covering the plurality of blades and configured to protect a user from cuts caused by the plurality of blades.

5. A cutting head for an electric razor according to claim 1, wherein the plurality of blades are integral to the blade support member.

6. A cutting heard for an electric razor according to claim 5, wherein the plurality of blades include a cutting surface formed at the edge of grooves cut into the blade support member.

7. A cutting head for an electric razor comprising:
a blade support member configured to attach to an electric razor;
a plurality of disc members attached to the blade support member in an array and configured to rotate about an axis such that the rotation is substantially planar with the blade support member; and
a plurality of blade members extending radially out from each of the plurality of disc members, the plurality of blade members moving in a cutting direction towards a hair to be cut and each of the plurality of blade members having a contact angle that is acute with respect to the cutting direction.

8. A cutting head for an electric razor according to claim 7, wherein the plurality of blade members are swept such that the blade member is convex with respect to the cutting direction.

9. A cutting head for an electric razor according to claim 7, wherein the plurality of blade members are swept such that the blade member is concave with respect to the cutting direction.

10. A cutting head for an electric razor according to claim 7, wherein the contact angle of each of the plurality of blade members is between 30 and 60 degrees.

11. A cutting head for an electric razor according to claim 7, wherein the contact angle of each of the plurality of blade members is substantially 45 degrees.

12. A cutting head for an electric razor according to claim 7 further comprising a screen covering the array of disc members and configured to protect a user from cuts caused by the plurality of blade members.

13. A cutting head for a razor comprising:
a blade support member configured to attach to a razor handle;
a plurality of blades located in and supported by the blade support member, the plurality of blades moving in a cutting direction towards a hair to be cut and having a contact angle that is acute with respect to the cutting direction.

14. A cutting head for a razor according to claim 11, wherein the contact angle is between 30 and 60 degrees.

15. A cutting head for a razor according to claim 11, wherein the contact angle is substantially 45 degrees.
